(19) United States
(12) Patent Application Publication
(10) Pub. No.: US 2012/0192010 A1
(43) Pub. Date: Jul. 26, 2012

(54) DATA ISOLATION WHILE SHARING INFORMATION BY A PLURALITY OF USERS WHEN EVALUATING PERFORMANCE OF A SERVER

(76) Inventors: Svetlana ARONOV, Rehovot (IL); Sagi MONZA, Rishon-Lezion (IL); Michal BARAK, Kiryat Ono (IL); Arnon MATHIAS, Kfar-Sava (IL)

(21) Appl. No.: 13/013,473

(22) Filed: Jan. 25, 2011

(51) Int. Cl. G06F 11/00

(52) U.S. Cl. 714/32; 714/E11.144

(57) ABSTRACT

A method for data isolation while sharing information by a plurality of emulated users for evaluating a performance of a server executing an application may include creating a master profile for use by the plurality of emulated users. The master profile may be configured to hold shared user related configuration information shared by the emulated users. The method may also include creating script profiles configured for a specific emulated user of the emulated users. A non-transitory computer readable medium and system are also disclosed.

### BACKGROUND

Many organizations spend a lot of money and time to study the performance of their offered applications running on computerized systems. Determining the quality level of a system performance is important both for long-run planning of better systems and for addressing imminent impediments on the performance of the system, as these occur, in order to remove these impediments immediately and prevent further degradation of service.

For example, LoadRunner, commercially available from Hewlett Packard (HP), is an automated performance and load testing product for examining system behavior and performance, which involves generating an actual load on the application under test (AUT). LoadRunner can emulate a multitude of concurrent users to put the AUT through the rigors of real-life user loads, while collecting information from key infrastructure components (Web servers, database servers etc.). The results may then be analyzed in detail, to explore the reasons for particular behavior.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. It should be noted that the figures are given as examples only and in no way limit the scope of the invention. Like components are denoted by like reference numerals.

FIG. 1 illustrates a method for evaluating the performance of a server executing an application, in accordance with embodiments of the present invention which includes creating a master profile and script profiles.

FIG. 2 illustrates creating of a master profile in accordance with embodiments of the present invention.

FIG. 3 illustrates a method for evaluating the performance of a server executing an application, in accordance with embodiments of the present invention, which include cascading master-based script profiles.

FIG. 4 illustrates a system for evaluating the performance of a server executing an application, in accordance with embodiments of the present invention.

### DETAILED DESCRIPTION

When evaluating the performance (hereinafter also referred to as “load”) of a server executing an application (e.g. a web application), it may be desired to provide a configurable isolated environment for every virtual user, while retaining the ability to share settings (configuration), easily sharing configuration and environment-related data (e.g. cache, cookies, history, bookmarks, etc.) between virtual users which may not compromise the isolation of each virtual user are disclosed herein.

When concurrently running a multitude of copies of a web automation script, it may be desired to isolate user related browser data (e.g. cache, cookies and client certificates) for each different virtual user. In one implementation, definitions may be shared between two or more virtual users when having isolated runtime environments. Additionally, if several different applications are being tested, different assets of preferences and definitions for each application may be tested per a virtual user.

For example, a profile in Firefox (a known web browser), is a collection of user related data, such as bookmarks, browsing history, site-specific settings, browser settings, cookies, security certificate setting, Secure Socket Layer (SSL) settings, extensions, passwords, proxy settings, and other personal settings. These items are stored in a special profile folder on a hard drive (e.g. on the network drive or on the user's local drive). Firefox uses a default profile to store all personal settings.

According to embodiments of the present invention two types of profiles are introduced which may be used to provide an isolated environment for each script. This may be performed in various load scenarios, e.g. during interactive script development and during load replay modes.

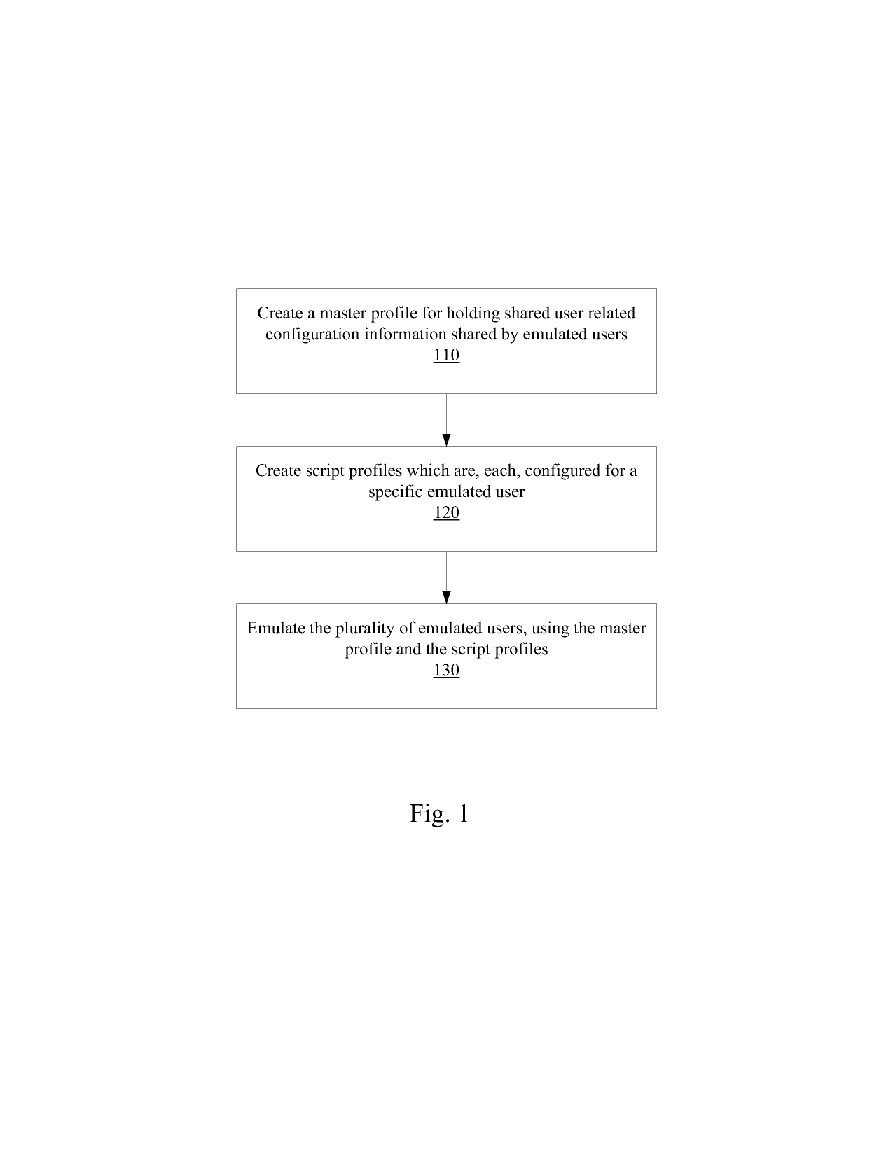

FIG. 1 illustrates a method for evaluating the performance of a server executing an application, in accordance with embodiments of the present invention which includes creating a master profile and script profiles. Such method may include creating 110 a master profile for use by a plurality of emulated users. The master profile may be designed to hold shared user related configurations and preferences (hereinafter related to as “shared user related configuration information”), which may be shared by the emulated users. The method may also include creating 120 script profiles which are, each, configured for a specific emulated user of said plurality of emulated users. The method may also include emulating 130 the plurality of emulated users, using the master profile and the script profiles.

In accordance with embodiments of the present invention, a master profile may be a base profile which contains shared user configuration related information applicable to corresponding script profiles. A master profile may be fully manageable. A user may modify his master profile, for example, by using a predefined wizard or during the browsing process.

A master profile may be a main default profile assigned to a user. A master profile may initially contain information on the location of template files necessary for the web browser (e.g. Firefox) to be properly initialized. The master profile may also contain extensions which are used by a software testing application, such as, for example HP's TruClient extensions. A master profile may be intended for configuration of global settings applicable to every newly created script (e.g. client certificates, Firefox add-ons, bookmarks, proxy settings, etc.)

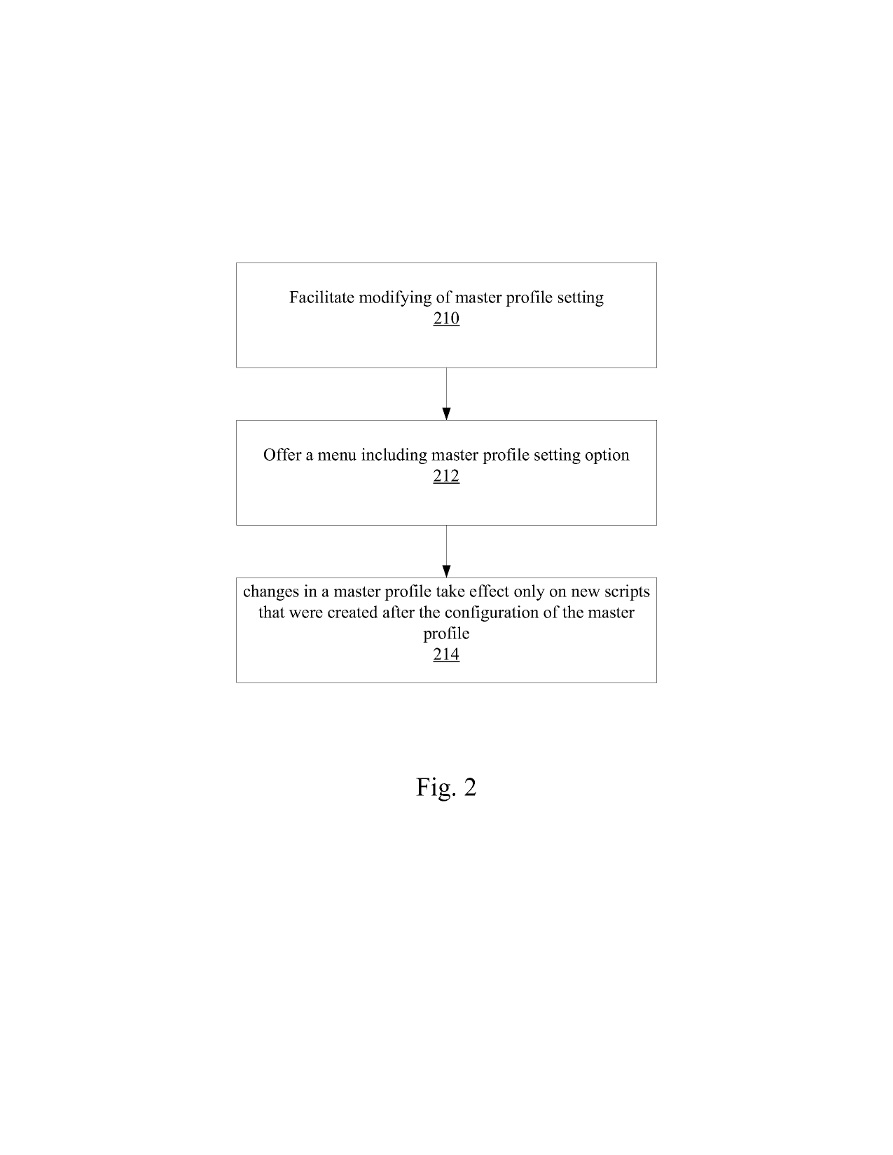

FIG. 2 illustrates creating of a master profile in accordance with embodiments of the present invention.

A testing tool may offer 210 a user the ability to modify a master profile. For example, the testing tool application may include a Graphical User Interface (GUI) which allows selecting from a menu various options, including 212 a master profile setting option.

For example, when configuring a master profile, a testing application may offer a menu, which may include in “browser options” a master profile setting option. A master profile setting may be applied using standard browser dialogues (e.g. Firefox standard dialogues), offering the user a familiar configuration environment. According to some embodiments of the present invention, changes in a master profile may take effect 214 on new scripts that were created after the configuration of the master profile.

A script profile, according to embodiments of the present invention, may be a profile that is “derived” from its master profile. In some embodiments of the invention, a script profile may serve as a master profile for another script profile. This may allow a user to create groups of profiles for different types of users.

A script profile—a script related to a profile, may refer to a master profile as a template during the creation (of the script profile). For standardization purposes, and in accordance with some embodiments of the present invention, a script profile may be located in a predetermined directory (e.g. {script directory}/profiles/interactive).

In accordance with embodiments of the present invention during the creation of a new script profile most of master profile data may be copied to the script profile directory.

For every add-on installed in a master profile, there may be a file with the same name in the script directory, which contains the path to the master profile extension.

In accordance with some embodiments of the present invention, a configuration change in the script profile (during interactive script development) may take effect only on that script profile and only if the script was saved after the change.

According to embodiments of the present invention, user related data of each user may be stored in the profile can be defined as private or shared. “Private data” may be considered any data that is stored in the master profile and used as a template for the initialization of newly created script profiles. When a private data element is modified, the “link” to the corresponding master profile may be removed by copying the data to the script profile. “Shared data” may be considered any data that is stored in a master profile. Each script profile of a master profile may use shared data (“linked”), and changes in the master profile may be reflected in all script profiles. A test engineer may be able to manage, for example, a master profiles graph (defining environmental data for every profile and “inheritance” relations between profiles preparatory to script recording. During the creation of a new script the development environment may instantiate a specific master profile, which may replicate the private data from its master profile to the script environment and link the shared data to the master profile environment.

According to embodiments of the present invention, an isolated environment may be created for every virtual user. This may improve user experience of the environment configuration, thus reducing required script development time. In accordance with some embodiments of the present invention, cascaded master-based script profiles may facilitate the creation of user groups for different types of virtual users. A script developer may associate a newly created sub-environment to a certain group quickly. This may prove very convenient in cases where a user tests several different applications, which require different assets of preferences and definitions.

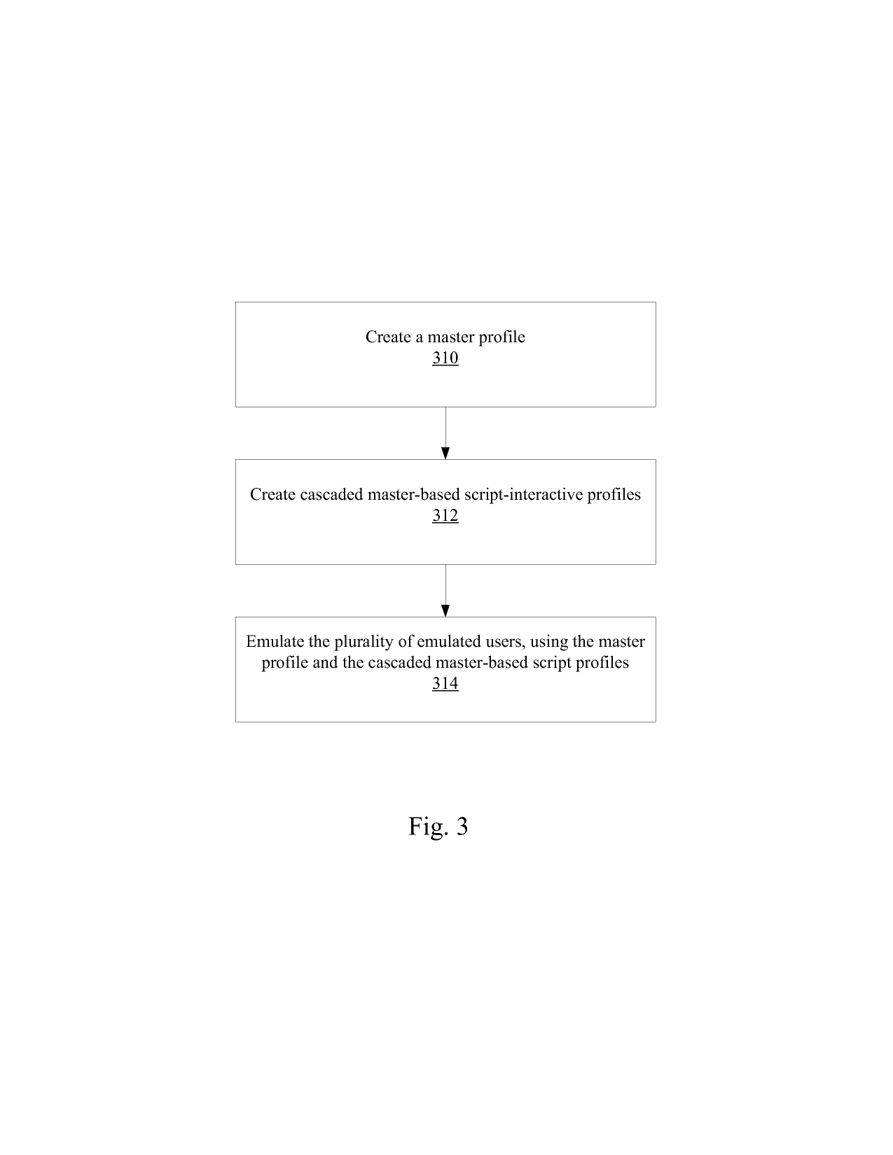

FIG. 3 illustrates a method for evaluating the performance of a server executing an application, in accordance with embodiments of the present invention, which include cascading master-based script profiles.

The method may include creating 310 a master profile. The method may also include creating cascaded master-based script profiles. The method may further include emulating 314 the plurality of emulated users using the master profile and the cascaded master-based script profiles.

In accordance with embodiments of the present invention a resource-based method may isolate environments, and may allow using of the actual script environment during web automation and not an emulated one, which may provide more reliability during script replay.

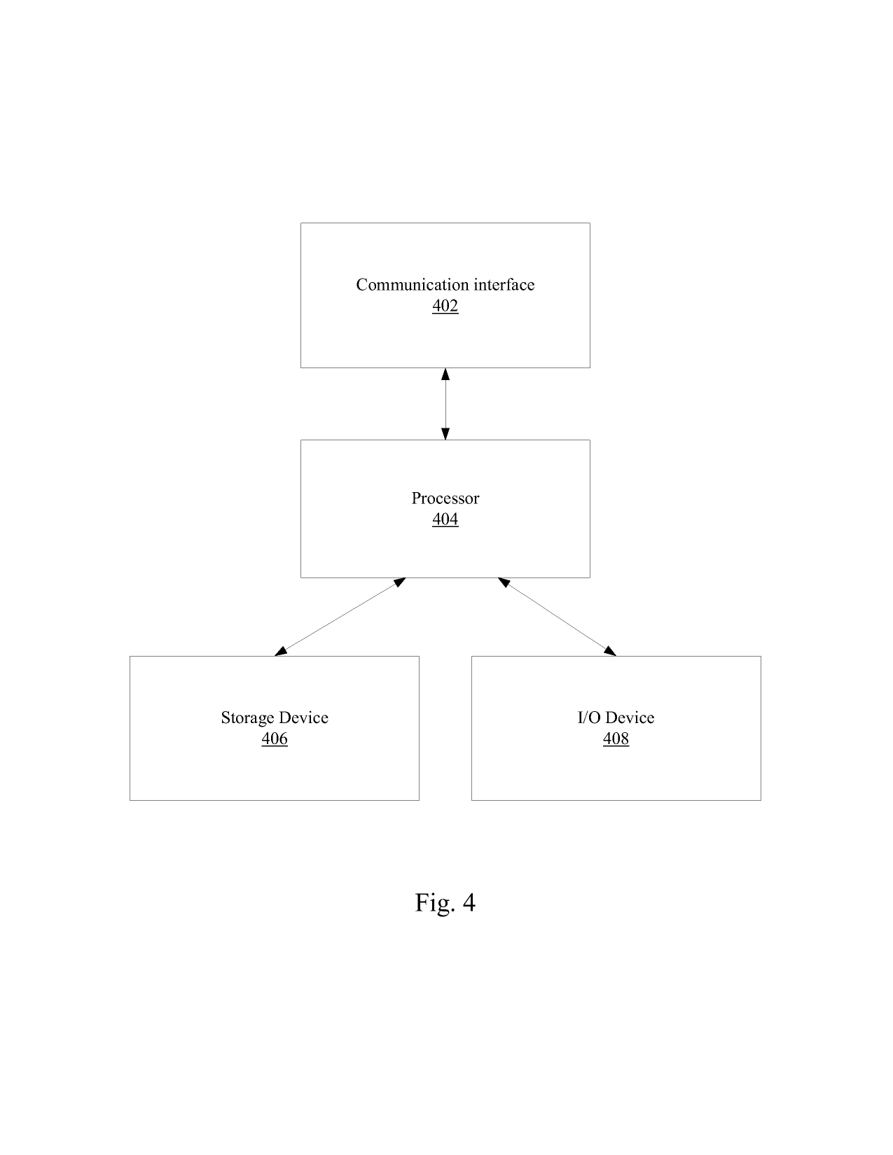

FIG. 4 illustrates a system for evaluating a performance of a server executing an application. The system may include storage device 406, such as, for example, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the above.

The system may also include a processor 404 to execute a computer executable program which includes instructions designed to evaluate the performance of a server executing an application, according to embodiments of the present invention. Such computer executable program may be stored on storage device 406.

The system may also include Input/Output (I/O) device 408 including a display interface for displaying to a user various Graphical User Interfaces (GUIs) of a testing application and other displayable information.

The system may further include a communication interface 402 for facilitating communication with a tested server or other devices.

Aspects of the present invention may be embodied as a computer program product saved on one or more non-transitory computer-readable mediums in the form of computer-readable program code embodied thereon. For example, the computer-readable medium may be a computer-readable storage medium. A computer-readable storage medium may be, for example, an electronic, optical, magnetic, electromagnetic, infrared, or semiconductor system, apparatus, or device, or any combination thereof.

Computer program code of the above described embodiments of the invention may be written in any suitable programming language. The program code may execute on a single computer, or on a plurality of computers.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A method for data isolation while sharing information by a plurality of emulated users for evaluating a performance of a server executing an application, the method comprising:
creating a master profile for use by the plurality of emulated users, the master profile configured to hold shared user related configuration information shared by the emulated users; and
creating script profiles configured for a specific emulated user of said plurality of emulated users.

2. The method of claim 1, further comprising emulating the plurality of emulated users, using the master profile and the script profiles.

3. The method of claim 1, comprising facilitating modifying of the master profile.

4. The method of claim 3, wherein a change in the modified master profile takes effect with respect to a new script created after the modifying of the master profile.

5. The method of claim 1, wherein the master profile is further configured to include at least one information item selected from the group of information items consisting of bookmarks, browsing history, site-specific settings, browser settings, cookies, security certificate setting, Secure Socket Layer (SSL) settings, extensions, passwords, proxy settings.

6. The method of claim 1, further comprising
using one of the script profiles as a master profile for one or more of remaining script profiles.

7. A non-transitory computer readable medium having stored thereon instructions which when executed by a processor cause the processor to perform the method of:
creating a master profile for use by a plurality of emulated users, the master profile configured to hold shared user related configuration information shared by the emulated users; and
creating script profiles which configured for a specific emulated user of said plurality of emulated users.

8. The non-transitory computer readable medium of claim 7, wherein the instructions further include emulating the plurality of users using the master profile and the script profiles.

9. The non-transitory computer readable medium of claim 7, wherein the instructions further include facilitating modifying of the master profile.

10. The non-transitory computer readable medium of claim 9, wherein a change in the modified master profile takes effect with respect to a new script created after the modifying of the master profile.

11. The non-transitory computer readable medium of claim 7, wherein the master profile is further configured to include at least one information item selected from the group of information items consisting of bookmarks, browsing history, site-specific settings, browser settings, cookies, security certificate setting, Secure Socket Layer (SSL) settings, extensions, passwords, proxy settings.

12. The non-transitory computer readable medium of claim 7, wherein the instructions further include using one of the script profiles as a master profile for one or more of remaining script profiles.

13. A system for data isolation while sharing information by a plurality of emulated users for evaluating a performance of a server executing an application, comprising a processor configured to:
create a master profile for use by the plurality of emulated users, the master profile configured to hold shared user related configuration information shared by the emulated users; and
create script profiles which configured for a specific emulated user of said plurality of emulated users.

14. The system of claim 13, wherein the processor is further configured to emulate the plurality of users using the master profile and the script profiles.

15. The system of claim 13, wherein the processor is further configured to facilitate modifying of the master profile.

16. The system of claim 15, wherein a change in the modified master profile takes effect with respect to a new script created after the modifying of the master profile.

17. The system of claim 13, wherein the master profile is further configured to include at least one information item selected from the group of information items consisting of bookmarks, browsing history, site-specific settings, browser settings, cookies, security certificate setting, Secure Socket Layer (SSL) settings, extensions, passwords, proxy settings.

18. The system of claim 13, wherein the processor is further configured to use one of the script profiles as a master profile for one or more of remaining script profiles.
